(19) United States
(12) Patent Application Publication
(10) Pub. No.: US 2006/0005653 A1
(43) Pub. Date: Jan. 12, 2006

(54) Enveloping worm transmission

(76) Inventor: Yakov Fleytman, Lake Orion, MI (US)

Correspondence Address: YAKOV FLEYTMAN, 3233 HICKORY DRIVE, LAKE ORION, MI, 48359, US

(21) Appl. No.: 11/227,836

(22) Filed: Sep. 14, 2005

Related U.S. Application Data
(63) Continuation-in-part of application No. 10/435,143, filed on May 9, 2003.
(60) Provisional application No. 60/464,044, filed on Apr. 21, 2003.

(51) Int. Cl. F16H 1/16

(52) U.S. Cl. 74/425

(57) ABSTRACT

An enveloping worm transmission is provided with a unique enveloping worm and worm gear with modified enveloping worm thread surfaces. Enveloping worm has general arrangements with worm gear on the face of worm gear. This invention offers combinations of enveloping worm with mating face worm gear where worm gear axis intersected, crossed or parallel to enveloping worm axis. The enveloping worm gear transmission is more efficient, quite and compact than conventional gear systems which have typically been used in power applications. The enveloping worm transmission of the present invention is easy manufacturing.

This is a continuation-in-part of Ser. No. 10/435,143 filed May 9, 2003

### FIELD OF THE INVENTION

An enveloping worm transmission is suitable for the transformation of motion and power between an enveloping worm and a worm gear wherein the axis of the worm gear and the worm may be crossed or intersected. The enveloping worm transmission includes one or multi-thread enveloping worm engaged with a worm gear. One potential application for this transmission is a helicopter rotor drive. As is known, one of the biggest problems, associated with helicopter rotor drives is noise. When compared to conventional spiral bevel gear transmissions, worm/gear type transmissions generate minimum noise. However, low efficiency and torque capacity associated with prior art worm/worm gear transmissions prevented their use in helicopter power transmission systems.

Certain applications may be outside of these fields, like automobile gearboxes, turbine gearboxes, power windows, doors or seats, power steering systems, chainless bicycle drive mechanism, and many industrial applications.

### BACKGROUND OF THE INVENTION

Worm/worm gear transmissions, in particular double enveloping speed reducers or Cone drive worm/worm gears, are well known in the mechanical power transmission field.

Standard enveloping worm is explained in AGMA STANDARD ANSI/AGMA 6030-C87 “Design of Industrial Double Enveloping Wormgears.

Many patents have a different name for the worm used in double enveloping transmission. “Globoid worm” is used in U.S. Pat. No. 1,792,782 by Trbojevich, “hourglass” worm is used in U.S. Pat. No. 1,822,800 by Cone. Some patents are using term “worm for use in double enveloping worm gearing” U.S. Pat. No. 2,279,414 by Scott.

A lot of patents support the term “enveloping worm”. U.S. Pat. No. 2,935,886 by Wildhaber is titled “Enveloping worm gearing”.

A worm of a double enveloping worm transmission is able to provide motion with two types of mating gears: enveloping mating gear or gears that could have an envelope around the worm body and none enveloping mating gear that is not able to have an envelope around the worm body. I named none enveloping mating gear as a face gear that is a generic term for this type of mating gear. A transmission with an enveloping worm in a face arrangement with a face mating worm gear where enveloping worm axis and the face gear axis are parallel, intersected or crossed cannot be double enveloping transmission. It is impossible to have an envelope on these face mating gears. It is distinguished from standard double enveloping worm transmission where it is possible to have an envelope on the mating gear.

In internal mesh of double enveloping gears the enveloping worm has an inverted envelope shape, where it is convex profile along axis of its rotation. Examples are shown in U.S. Pat. No. 2,208,614 by Watson and U.S. Pat. No. 5,387,162 by Tai-Her Jang.

The worm gear is driven by the rotation of the worm with which it meshes. The rotational speed of the associated shaft of the worm gear is a function of the number of teeth on the worm gear and the number of threads on the worm. The worm may be single or multiple threaded. In all standard double enveloping worm/worm gear transmissions, the enveloping worm gear has a surface that is generated by the profile of an enveloping thread of the worm. The term “Generated” describes how the profile of a worm gear tooth may be defined. It could utilize mathematical calculations defining the profile from equations of the surface of the enveloping worm thread; hobbing of a gear blank by a tool, having the profile of the worm thread; or via computer modeling, where the profile of a 3D solid worm gear is cut by the profile of a 3D solid worm thread. Conventional enveloping worm/worm gear transmissions are using worm thread with at least one revolution of the thread or 360 degrees of revolution. Drive faces of the worm thread has a concave and a convex surface and coast face of the thread also has concave and convex surfaces.

According to the Popov (U.S. Pat. No. 4,047,449), in order to increase the amount of tooth contact by increasing the number of teeth in actual contact, the enveloping worm has more than one revolution of the thread.

The McCartin patent (U.S. Pat. No. 3,597,990) discloses a transmission with enveloping worm meshed with threaded followers. Thus, the McCartin gear with threaded followers is not able to have an envelope profile. Profiles of standard enveloping worm gear teeth usually have a profile generated by hobbing. However, the McCartin thread followers could not be made by hobbing or by generation of the worm thread profile. McCartin drive is used for indexing motion and does not have a self-lock feature. McCartin patent can use one thread with more than two revolutions for accurate indexing.

In my patent (U.S. Pat. No. 6,093,126), there is a split-enveloping worm. However, the split half is able to transmit motion only in one direction. To reverse the direction of motion it uses the other half. This means that only one surface of the worm thread is able to transmit motion. Each side of a thread of a split-enveloping worm has a concave surface and a convex surface. Only the concave surface is able to transmit torque and the convex surface doesn't have any mesh with a gear's tooth. This problem is present in all existing transmissions with an enveloping worm (Faydor Litvin 1994, Gear Geometry and Applied Theory. PTR Prentice Hall, Englewood Cliffs, N.J. pages 599-612). In my patents U.S. Pat. No. 5,992,259 and U.S. Pat. No. 6,148,683 the enveloping worm can be one half or less of a split worm, which can have only one supporting shaft. Using only half or less than a half of the split worm gear or enveloping worm allows for easier assembly of the enveloping worm with the worm gear. The enveloping worm according with my patent mentioned above is also able to transmit motion by concave side of the thread with very good surface contact and by convex part of the thread despite very poor contact between surfaces of worm thread and gear tooth. The concave part of the enveloping worm thread has good contact with half of the gear width and the contact by the edge of the thread with another half of the gear.

In known face gear drive by Litvin, patent (U.S. Pat. No. 6,128,969) has involute worm as it was described on the column 1 lines 29 and 61 respectfully and column 3 line 49. More on the column 3 lines 51, 52 “the pinion 5 defines a cylindrical multi-thread involute worm”. In the column 4 line 14 pinion is also defined as a helical involute pinion that is also standard type gear which has a cylindrical shape along axis of worm rotation. In the claims 1 and 2 Litvin worm is cylindrical worm, not enveloping. Enveloping worm has a variable section shape and it is not involute and cannot be defined by “involute” shape term. In the enveloping worm the shape of the pinion having circular shape in any section along its axis of rotation. It is not cylindrical shape. Litvin patent does not teach that pinion can be enveloping worm.

In the patent Candee et al. (U.S. Pat. No. 1,683,758 in the independent claims 1-5, 10, 11, 14 the worm is cylindrical worm. In the claims 6-9, 18 the worm is involute helicoidal worm that is also standard worm and has a cylindrical shape. Candee patent does not teach that pinion can be enveloping worm.

In Wildhaber patent (U.S. Pat. No. 1,694,028) is hypoid type pinion in face arrangement with mating gear (FIG. 3, FIG. 4). It has no support that the pinion is enveloping worm in description or in the claims. In Wildhaber patent is hypoid type pinion in face arrangement with mating gear (FIG. 3, FIG. 4). It has no support that the pinion is enveloping worm in description or in the claims. Wildhaber patent does not teach that pinion can be enveloping worm.

In Saari patent (U.S. Pat. No. 2,954,704) there is no support that the pinion is enveloping worm in description. On the contrary in all independent claims it says that “said pinion being cylindrical”.

Saari patent does not teach that pinion can be enveloping worm.

### SUMMARY OF THE INVENTION

Enveloping worm transmission with teeth surface generated by profile of a thread where an enveloping worm having at least one screw thread that is engaged by at least one tooth of said worm gear has limitations to transferring torque mostly by concave surface of the worm thread. It is also very important to use an enveloping pinion with different types of the worm gears, like face gears. It is convenient to generate enveloping worm thread profile by the base profile of the involutes rack (cutter) rolls around the base circle where the pinion tooth section is always on the same angle to the gear circle. It does not roll around it, it just transfers around it. The position of an enveloping worm thread in mesh with a worm gear placed on the axis of the base circle is the original position.

In this invention each side of a thread: concave surface and a convex surface is able to transmit torque, that is distinguished from double enveloping gearing. In addition, by transmitting torque this new enveloping worm transmission is able to back drive from the worm gear to the enveloping worm. For the same size of the pinion, this invention has more torque capacity of traditional hypoid gearing.

This invention offers new and unobvious combinations of enveloping worm with mating face worm gear where new worm gear axis is intersected, crossed or parallel to enveloping worm axis.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 an enveloping worm transmission known from previous art with enveloping worm with less than one revolution of threads;

FIG. 2 shows a machine setting for machining enveloping worm with concave shape by using a rotating tool;

FIG. 3 shows a machine setting for machining an inverted enveloping worm with convex shape by using a rotating tool;

FIG. 4 is a plain view of a design with an enveloping worm placed on the face of worm gear without offset with enveloping worm having 90 degrees of revolution of threads;

FIG. 5 is a plain view of a design with an enveloping worm placed on the face of worm gear with offset with enveloping worm having 90 degrees of revolution of threads;

FIG. 6 is an isometric view of a design with an enveloping worm placed on the face of worm gear without offset with enveloping worm having 180 degrees of revolution of threads;

FIG. 7 is a plain view of a design with an enveloping worm gear transmission with less than 90 degrees an angle between worm axis and face worm gear axis according to the principles of the present invention;

FIG. 8 is an isometric view of an enveloping face gears with enveloping worm having threads with less than one revolution and with parallel shaft's axes of rotation;

FIG. 9 is an isometric view of a design with an enveloping worm placed on the face of worm gear without offset with enveloping worm having less than 90 degrees of revolution of threads;

FIG. 10 is an isometric view of a design with an enveloping worm placed on the face of worm gear with offset with enveloping worm having less than 90 degrees of revolution of threads;

FIG. 11 is an isometric view of a design with an inverted enveloping worm placed on the face of worm gear with offset with enveloping worm having less than 90 degrees of revolution of threads;

FIG. 12 is an isometric view of a design with an inverted enveloping worm placed on the face of worm gear with offset with enveloping worm having more than 360 degrees of revolution of threads;

FIG. 13 is an isometric view of a design with an inverted enveloping worm placed on the face of worm gear with offset and placed on the face of worm gear without offset and placed on the face of worm gear with parallel axes of rotation where said enveloping worm has less than 90 degrees of revolution of threads.

### DETAILED DESCRIPTION OF THE PREFERRED EMBODIMENTS

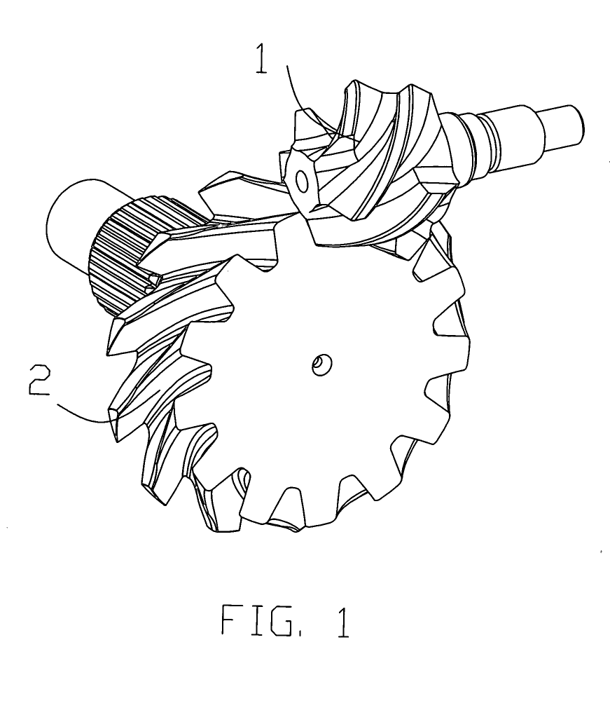

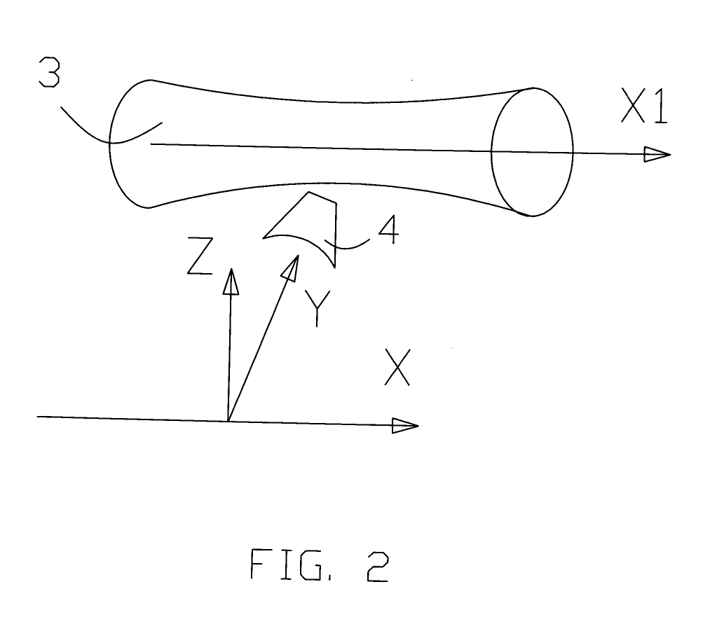

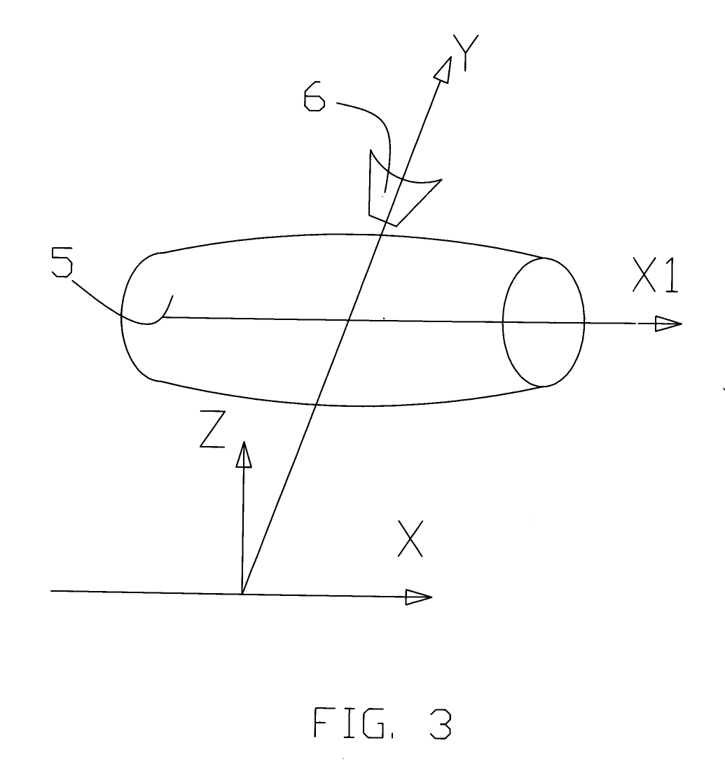

The following discussion relating to FIGS. 1-13 provides a detailed description of the unique enveloping worm gear transmissions that can be utilized with the present invention.

More torque capacity is the main advantage for using the enveloping worm transmission. The enveloping worm mostly has a rolling action contact relationship with the teeth of the worm gear that provides an increased efficiency. With standard double enveloping worm designs, having more than one thread and a large enveloping angle, the inability to assemble the worm and worm gear was considered a major obstacle. With the enveloping worm and worm gear of the present invention, the enveloping worm and worm gear are easily assembled by properly orienting the worm thread and worm teeth. According to the present invention, the greater enveloping angle for one revolution of a worm thread permits the use of worm gear teeth without undercut portions.

Referring now to the drawings, one embodiment of an enveloping worm transmission of the present invention is illustrated in FIG. 1. It consists of enveloping worm 1 which engages with an enveloping worm gear 2 according with Fleytman patent (U.S. Pat. No. 6,148,683). In current invention we are using the same enveloping worm but in mesh with a face gear, that can not be with an enveloping shape.

Convention enveloping worm with concave shape of a profile along the axis X1 of it rotation can be cut from a blank 3 with cutting tool 4. Tool 4 rotates in plane Y and X around axis Z with ratio time slower than rotation of blank 3 around its axis of rotation X1.

Inverted enveloping worm with convex shape of a profile along the axis X1 of it rotation can be cut from a blank 5 with cutting tool 6. Tool 6 rotates in plane Y and X around axis Z with ratio time slower than rotation of blank 5 around its axis of rotation X1.

In known double enveloping worm gear the only working mesh is by concave part of an enveloping thread with a mating worm gear. Many production companies have techniques for modifying a worm thread profile to avoid generation of the mating enveloping worm gear profile by the edge of a thread. They change the position of the cutter to machine modified concave and convex surfaces of the enveloping worm thread. For example worm gear that has a predetermined surface is well known as Wildhaber enveloping transmission U.S. Pat. Nos. 1,903,318, 2,935,886. In his enveloping transmission a hob and enveloping worm thread surfaces are generated by spur planes in orthogonal rotating axis and worm gear tooth surfaces is spur plane milled by plane milling cutters. The Wildhaber's idea of modification has serious undercutting and pointing problems on the enveloping worm; that is why it is only used for high gear ratios, more than 1:40. The goal of this invention is to able to produce tooth of mating gear profile by surface of the enveloping thread, not the edge of the thread. The surface of mating worm gear teeth should be determined by the surface of the thread or threads of the enveloping worm using both sides of the thread: convex and concave. A computer model simulation can be utilized to produce the surface of the worm gear tooth. The worm gear can also be formed using known techniques such as hobbing by using profile of the enveloping worm pinion as a master gear.

When the mating worm gear teeth are produced by the concave and convex surfaces of the enveloping worm threads we call this worm gear a face gear. These principles of the face gear producing could be applied to any degree of revolution of the worm thread: less than 90, 90, less than 180, 180, less than 360, 360 and more than one revolution of the thread. Longer worm thread has better contact ratio, but for low kinematics ratios (for example, less than 1:8) it is more difficult to manufacture enveloping worm transmission and even to assemble an enveloping worm with a worm gear.

We have new enveloping worm transmission comprising: a face worm gear and an enveloping worm, said enveloping worm having at least one screw thread that is engaged by at least one tooth of said worm gear said enveloping worm is placed into face arrangement with said face worm gear. This enveloping worm transmission could have many design variations. The enveloping worm is well known enveloping worm of double enveloping worm/worm gear transmission.

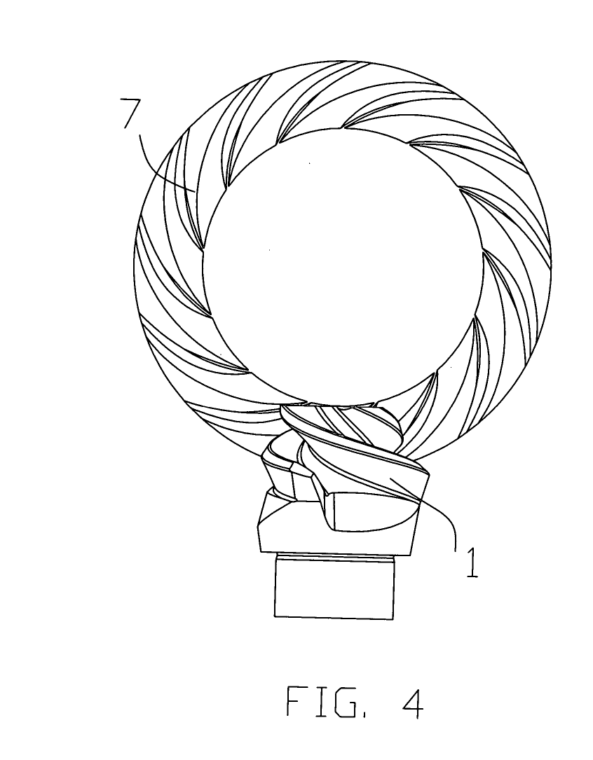

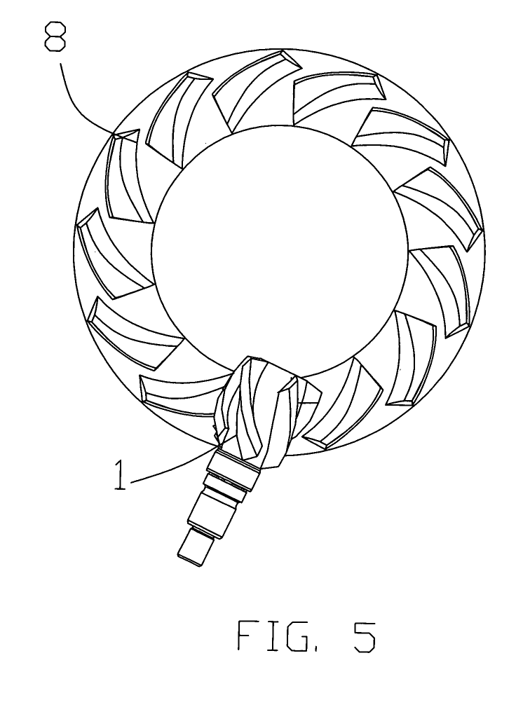

The same enveloping worm thread from FIG. 1 was used with different designs of face gears on the FIG. 4, FIG. 5, and FIG. 7. FIG. 4 is a plan view of a design with an enveloping worm 1 placed on the face of worm gear 7 without offset (similar to spiral bevel gear). Enveloping worm 1 has 90 degrees of revolution of threads.

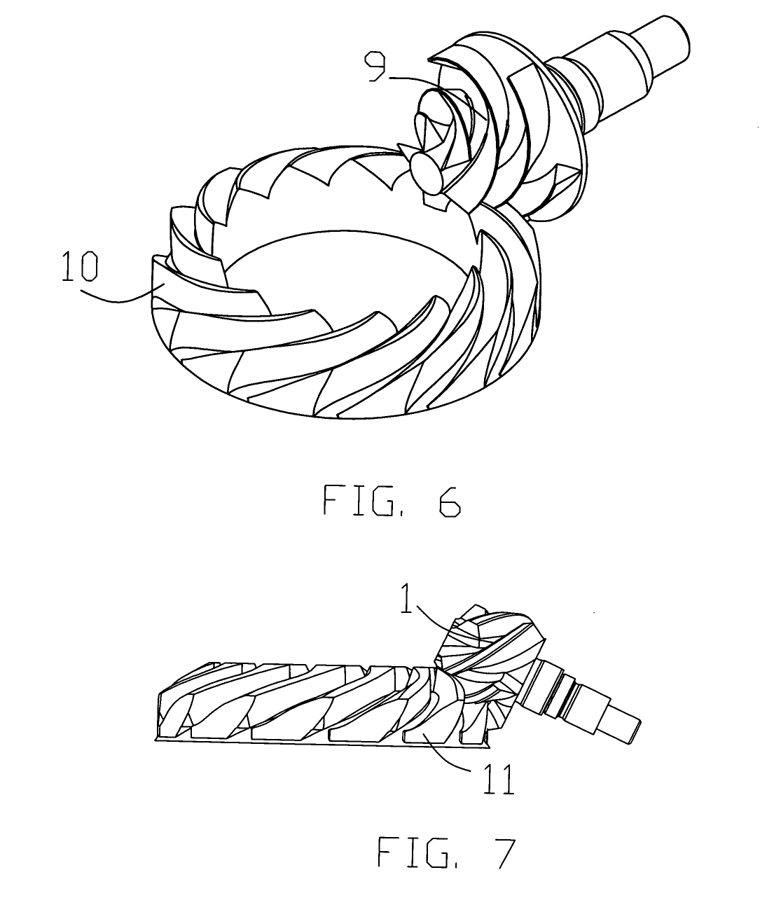

FIG. 5 is a plain view of a design with an enveloping worm 1 placed on the face of worm gear 8 with offset (similar to hypoid gear). Enveloping worm 1 has 90 degrees of revolution of threads. FIG. 6 is a plain view of a design with an enveloping worm 9 placed on the face of worm gear 10 without offset (similar to spiral bevel gear). Enveloping worm 9 has 180 degrees of revolution of threads.

FIG. 7 is a plain view of a design with an enveloping worm gear transmission with less than 90 degrees an angle between worm 1 axis and face worm gear 11 axis according to the principles of the present invention.

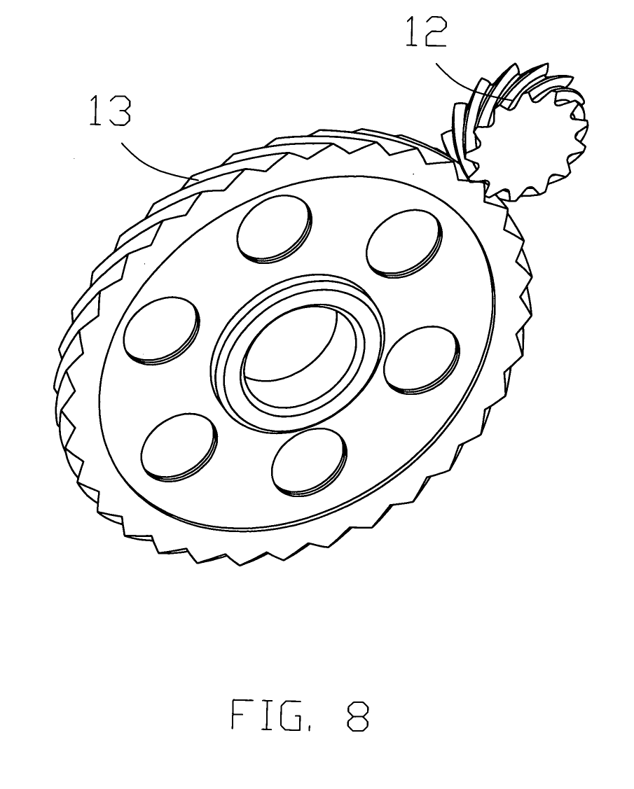

FIG. 8 is an isometric view of an enveloping face gears with enveloping worm 12 having threads with less than one revolution in mesh with a face gear 13 with parallel shaft's axes of rotation.

The enveloping worm was repositioned in different arrangement with the mating face gear but the topology of the face gear teeth surfaces is the same and mesh between a surface of worm thread and a surface of face gear teeth becomes possible. This is a non obvious usage of well known enveloping worm.

The surface of enveloping worm for different designs of enveloping face worm transmissions could be made by the same principals as described for conventional double enveloping worm transmission. In different designs said enveloping worm axis and said face gear axis are crossed, parallel or intersected.

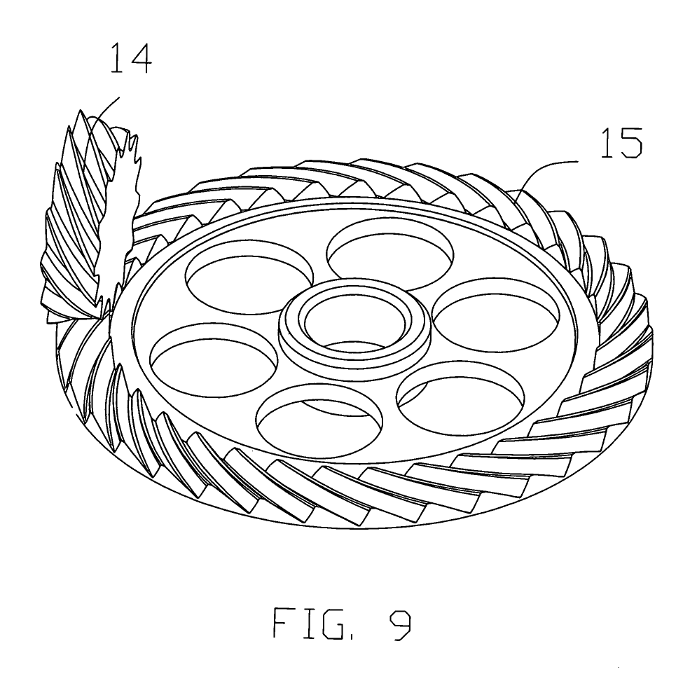

FIG. 9 is an isometric view of a design with an enveloping worm 14 placed on the face of worm gear 15 without offset with enveloping worm having less than 90 degrees of revolution of threads.

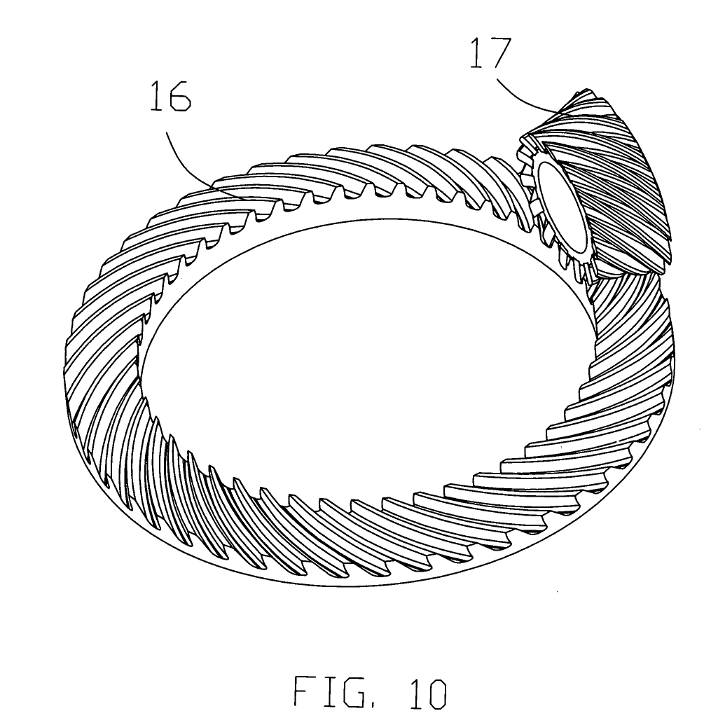

FIG. 10 is an isometric view of a design with an enveloping worm 16 placed on the face of worm gear 17 with offset with enveloping worm having less than 90 degrees of revolution of threads.

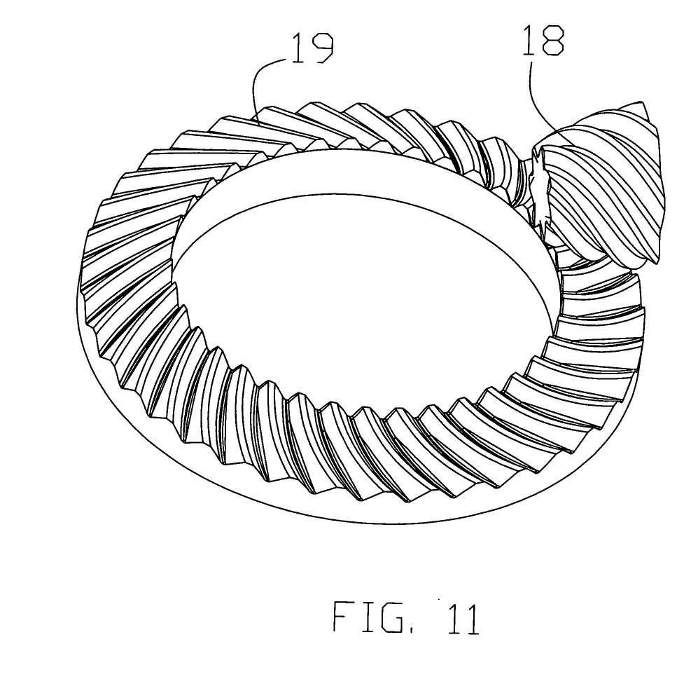

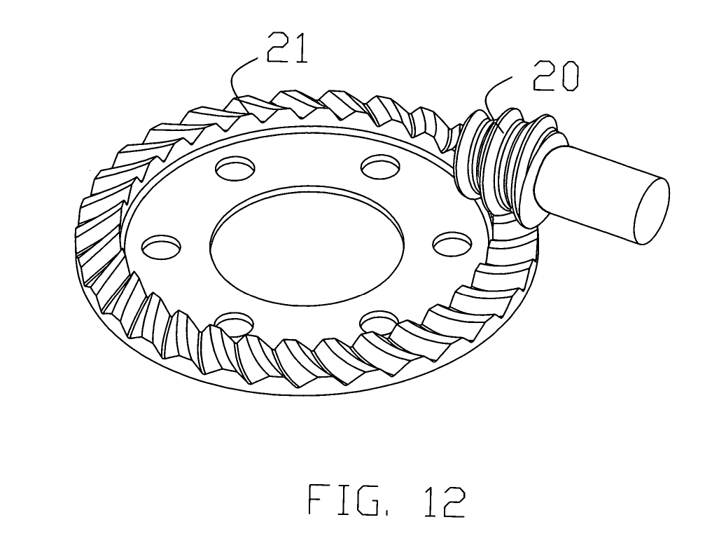

FIG. 11 is an isometric view of a design with an inverted enveloping worm 18 placed on the face of worm gear 19 with offset with enveloping worm 18 having less than 90 degrees of revolution of threads. FIG. 12 is an isometric view of a design with an inverted enveloping worm 20 placed on the face of worm gear 21 with offset with enveloping worm 20 having more than 360 degrees of revolution of threads.

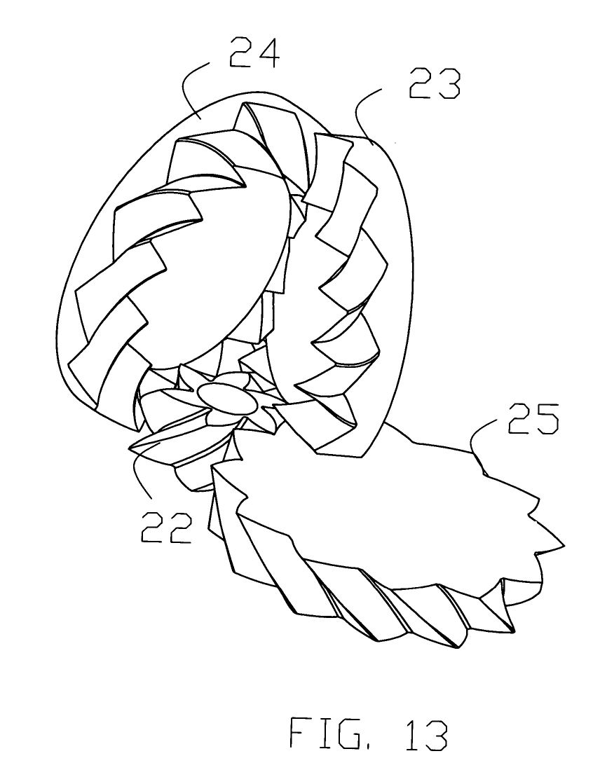

FIG. 13 is an isometric view of a design with an inverted enveloping worm 22 placed on the face of worm gear 23 with offset and placed on the face of worm gear 24 without offset and placed on the face of worm gear 25 with parallel axes of rotation where said enveloping worm 22 having less than 90 degrees of revolution of threads. FIG. 13 is example of general statement that one enveloping worm from double enveloping worm gear drive able to have a working mesh with different mating face gears, where said enveloping worm axis and said face gears axes are crossed, parallel or intersected.

The preferable shape of the teeth and threads for the worm gear and the worm are shown in the drawings, but could be different. Even so, a worker of ordinary skill in the art would recognize that other shapes would come within the scope of this invention.

For back drive, when the worm gear is a driven member and the enveloping worm is a driving member, this enveloping worm transmission also has high efficiency compared to a hypoid gearset. It was confirmed by testing of a steel enveloping worm transmission constructed according to the present invention. Up to now, those skilled in the art were of the opinion that an enveloping worm transmission requires unique machining technology that presents an insurmountable barrier to commercial applications. But now, by using more simplified enveloping worm with thread with less than 180 degree of revolution it is possible to use existing technology for already producing gears, like for hypoid and spiral bevel gears.

The shape of the enveloping worm and open teeth shape of the mating face worm gear allows to use very productive technology, like forging, or casting. The basic inventive system of the present invention can be reconfigured into many different mechanical transmissions. For example, it can be used in main drive of helicopter transmission, a front axle drive and differential drive rear axle of a car, power windows, escalator drive, and more. The enveloping worm transmissions described above can be utilized in a power take-off unit of a four-wheel drive transaxle.

More efficient motion of enveloping worm face gears and ultra high torque capacity and lower production cost makes these new gears very competitive against known helical, face, spiral bevel and hypoid gears.

### General Advantages of Enveloping Worm Transmission

The invention has high torque capacity due to surface to surface contact mesh that reduces contact stresses and increases the torque capacity of the enveloping worm transmission. The above described gear transmission is transmitting more power with a smaller size. It is a compact alternative for helical, hypoid and spiral bevel gears in almost any application, especially in power expended applications, like helicopters, ships, boats and cars.

For the same pinion size, this invention can provide more torque capacity of hypoid, helical, spiral and bevel gearing.

Contact pattern of motion along the tooth line: from the left to the right or from the right to the left depending on the direction of rotation. In hypoid gears contact pattern of motion across the tooth: from the root to the tip or from the tip to the root depending on the direction of rotation. Enveloping gear has better lubrication condition (suction vs. squeezing out) that may reduce the cost in assembly and increase driving efficiency. The efficiency of the new enveloping worm transmission is equal to or even greater than efficiency in well-known spiral bevel gearing, which are used in right angle drives or helical gearing, which are used in parallel shaft drives.

In the traditional engineering practice enveloping (double enveloping) gears have been used with the ratio 1:5 and higher. Hypoid and spiral bevel gears have always been used in the lower ratio applications. For the ratio less than 1:5 the invention can be more efficient than any right angle gears. Enveloping worm transmission has higher percentage of rolling/sliding motion and excellent dynamic lubrication. It has extending life even without lubrication. Invention can replace any right angle gears, especially in power sensitive applications, like helicopters, ships, boats and cars. In automotive power train applications like front and rear drive axles, power take-off units, transmissions, traction systems and mechanical amplifiers it saves space up to 30% and significantly reduces weight. It will work in power windows and power seats, steering drives.

Enveloping worm transmission can be also used in high ratio applications. Manufacturing errors in machining of any gears are function of cutting tool geometry and kinematical error of a machine. For enveloping worm transmission only kinematical error of a production machine may be significant. For this reason gears in this invention can be produced more accurately, especially in mass production.

Asymmetric profile of the enveloping pinion with less than 180 degree of thread revolution allows backlash adjustment by linear tuning of the pinion along the axis of its rotation. This is very important to gears with parallel shaft axes. Helical gears can not be adjusted in this manner. Most of the time each thread of the enveloping worm is in mesh longer than any other known gear's pinions. It reduces impact of engagement and disengagement, increases the contact ratio and makes quieter motion. One directional motion of contact pattern along gear tooth produces friction forces in one direction that also helps to reduce noise. The lower noise of the enveloping worm transmission compared with hypoid and bevel gear transmissions make using the enveloping worm transmission of the present invention more beneficial, particularly in helicopter or in motor vehicle power train applications.

Using existing gear cutting machines can make enveloping worm transmission cheaper than hypoid or spiral bevel gears. Sharpening of cutting tool, to generate enveloping worm pinion by hobbling where cutting edges are placed on the planes that are perpendicular to an axis of rotating hob, is less expensive than sharpening of cutting edges of traditional hob for helical gears generation. This makes production of enveloping worm transmission with parallel shafts cheaper than standard helical gears with parallel shafts. For some configuration forging technology or power metallurgy could be applied as well. There are very broad opportunities for the enveloping worm transmission made from plastic. A none enveloping face mating gear to an enveloping worm (known worm of double enveloping worm transmission) is recite novel structure. This novel structure is distinguished physically over every reference and the physical distinctions affect new and unexpected results. In these results transmissions have different relative positions of input and output axis of rotation from known double enveloping worm transmission and are also able to provide more efficient motion, thereby indicating that the physical distinction are unobvious.

In the invention being thus described, it is obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. The enveloping worm transmission comprising:
a worm of a double enveloping worm transmission and a worm gear, said worm having at least one thread that is engaged by at least one tooth of said worm gear wherein said worm gear is a face gear and a said worm is in a face arrangement with said worm gear.

2. The enveloping worm transmission as recited in claim 1, wherein said thread has 360 degrees or less than 360 degrees of revolution.

3. The enveloping worm transmission as recited in claim 1, wherein said thread has 180 degrees or less than 180 degrees of revolution.

4. The enveloping worm transmission as recited in claim 1, wherein said thread has 90 degrees or less than 90 degrees of revolution.

5. The enveloping worm transmission as recited in claim 1, wherein said worm axis and said face gear axis are intersected.

6. The enveloping worm transmission as recited in claim 1, wherein said worm axis and said face gear axis are crossed.

7. The enveloping worm transmission as recited in claim 1, wherein said worm axis and said face gear axis have 90 degrees or less than 90 degree angles.

8. The enveloping worm transmission as recited in claim 1, wherein said worm axis and said face gear axis are parallel.

9. The enveloping worm transmission as recited in claim 1, wherein said thread has 360 degrees or more than 360 degrees of revolution.

10. The enveloping worm transmission comprising:
a worm of a double enveloping worm transmission and a worm gear, said worm having at least one thread that is engaged by at least one tooth of said worm gear wherein said worm gear is a face gear and a said worm has an inverted envelope shape and in a face arrangement with said worm gear.

11. The enveloping worm transmission as recited in claim 10, wherein said thread has 360 degrees or less than 360 degrees of revolution.

12. The enveloping worm transmission as recited in claim 10, wherein said thread has 180 degrees or less than 180 degrees of revolution.

13. The enveloping worm transmission as recited in claim 10, wherein said thread has 90 degrees or less than 90 degrees of revolution.

14. The enveloping worm transmission as recited in claim 10, wherein said worm axis and said face gear axis are intersected.

15. The enveloping worm transmission as recited in claim 10, wherein said worm axis and said face gear axis are crossed.

16. The enveloping worm transmission as recited in claim 10, wherein said worm axis and said face gear axis have 90 degrees or less than 90 degree angles.

17. The enveloping worm transmission as recited in claim 10, wherein said worm axis and said face gear axis are parallel.

18. The enveloping worm transmission as recited in claim 10, wherein said thread has 360 degrees or more than 360 degrees of revolution.
